(19) United States
(12) Patent Application Publication
(10) Pub. No.: US 2010/0071132 A1
(43) Pub. Date: Mar. 25, 2010

(54) BED HAVING AN ADJUSTABLE HEAD REST

(76) Inventor: Hans-Peter Barthelt, Esslingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/513,605

(22) PCT Filed: Oct. 11, 2007
(86) PCT No.: PCT/EP07/08845

§ 371 Date: May 5, 2009

(30) Foreign Application Priority Data
Nov. 7, 2006 (DE) 10 2006 052 699.6

(51) Int. Cl. A61G 7/015; A61G 7/018

(52) U.S. Cl. 5/613

(57) ABSTRACT

A hospital bed features a bed frame that is provided with a movable back rest and a movable head rest. A mechanism ensures that the head rest and the back rest can be moved by means of a single motor. Lifting of the back rest begins after the head rest has reached the maximum raised position.

### CROSS-REFERENCE TO RELATED APPLICATIONS

This patent application is the national phase of PCT/EP2007/008845, filed Oct. 11, 2007, which claims the benefit of German Patent Application No. 102006052699.6, filed Nov. 7, 2006.

### FIELD OF THE INVENTION

The present invention relates generally to adjustable beds and, more particularly, to an adjustable bed having a movable back rest and a movable head rest driven by a single motor.

### BACKGROUND OF THE INVENTION

The bed frame of hospital beds, on which the mattress is situated, is divided into several sections. This is intended to make it possible to raise the feet and/or back of a patient relative to a central region or the legs.

The adjustment of the back region of the bed frame is effected by an electric motor that raises or lowers the back rest by means of a screw spindle. However, a manually actuated ratchet mechanism is used to adjust the head rest. Consequently, a patient lying in the bed is unable to adjust the head rest. A completely flat position can only be achieved with the assistance of an aide who flattens the head rest. The patient is also unable to raise the head rest by himself. This also requires an aide who moves the head rest into the raised position. The patient further is unable to adjust the head rest to different intermediate positions.

### OBJECTS AND SUMMARY OF THE INVENTION

It is an object of the present invention to provide a hospital bed in which the back rest as well as the head rest of the bed frame can be adjusted in a motor-driven fashion with the aid of a single drive operated by a person lying in the bed.

In the disclosed hospital bed, the bed frame on which the mattress is situated is divided into several sections or segments in a conventional manner. One of the segments forms the back rest, i.e., the section on which the back of the patient lies. The head rest is situated adjacent to the back rest or the back segment, wherein the articulation axis between the two sections extends approximately at the region of the neck of a person lying in the bed.

The adjustment of the back rest is effected with a linear motor, the movement axis of which extends at an acute angle relative to the head rest. The arrangement is effected in such a way that the movable end of the linear drive moves in the direction of the head rest, i.e., in the distal direction, when the linear drive is extended.

In order to enable an automatic motion of the head rest, the linear drive acts on the back rest by means of an intermediate or pivoted lever. A coupling bar extends from the pivoted or intermediate lever to the head rest. A sequential movement of the head rest and the back rest is achieved through such arrangement.

When the linear drive is activated in the position in which both bed frame sections lie flat, the head rest initially moves into a raised or upwardly angled position. The back rest does not begin to rise until the fully extended or final position of the head rest is reached. This enables the patient to reach a comfortable head position. This also prevents a less ergonomically desirable head position in which the head lies flat and the back is raised. The patient can automatically adjust, without assistance, the corresponding positions by means of the linear drive.

The back rest preferably has two longitudinal side rails, each of which is connected to the central section by means of a corresponding hinge. The coupling of the back rest is described in DE 103 30 759, which is incorporated herein by reference, is particularly useful in hospital beds with rotatable bed frames, and can be easily used if the back rest has two extended longitudinal side rails that extend laterally adjacent to and project beyond the head rest. The longitudinal side rails are connected to one another by a cross brace at their free end, and the head rest is supported in a pivoting fashion between the longitudinal side rails.

A load-independent limitation of the raising motion of the head rest is achieved if the pivoting motion of the intermediate lever is indirectly or directly limited in the sense of raising or lowering the back rest. This limitation can be accomplished by limiting the pivoting motion of the head rest on the back rest or by providing the intermediate lever with a stop that limits the extent to which the head rest may be raised.

The lowering of the head rest can be limited with stops that are provided on the longitudinal side rails of the back rest or with another stop on the pivoted lever. The intermediate lever can be hinged to the back section by means of a support hinge. A driving hinge can connect the pivoted lever to the linear drive, wherein the axes of the supporting hinge and of the driving hinge lie in a common plane.

Favorable force relationships are achieved if the plane in which the two axes lie is angled relative to the back rest by more than 60°, preferably more than 70°. This ensures that the head rest without any other load is always raised first before the back rest begins to rise.

The intermediate lever is connected to the coupling bar by means of a coupling bar hinge. The axis of the coupling bar hinge lies in a plane that also includes the axis of the supporting hinge. The plane thus formed can be angled relative to the back rest by more than 80° when the back rest and the head rest lie in a common plane, i.e., when the back rest is completely lowered.

The intermediate lever can be formed by a plate that contains three holes with hinge pins inserted therein. In order to prevent the intermediate lever from tilting laterally, the hole that indirectly forms the supporting hinge can contain a bushing that is rigidly connected to the plate.

If the coupling bar consists of two congruent partial braces that are connected by spacer elements, special fork heads on the ends are not necessary. This also makes it possible, in particular, to effect complicated coupling bars such that the coupling bar can extend past other transversely extending structural elements of the bed. The utilization of two congruent partial braces makes it possible to easily manufacture the respective partial brace in the form of a laser-cut part. Since each individual partial brace is relatively thin, energy required for the cutting process is low and dimensionally accurate parts can be very precisely produced.

The coupling bar can act on the head rest using a lever that is rigidly connected to the head rest. The lever is preferably situated on a cross brace of the head rest in the vicinity of the hinge axis along which the head rest can be moved relative to the back rest. The effective lever length by means of which the coupling bar acts on the head rest and introduces the turning moment, can lie between 0.8-times and 1.5-times the axial spacing between the coupling bar hinge and the supporting hinge.

The axial spacing between the supporting hinge and the driving hinge preferably lies between 20 mm and 80 mm. The smaller this spacing, the higher the force required for raising the head rest, which can lead to the head rest not being initially raised in the unloaded state when the driving motor is activated.

A screw spindle drive preferably serves as a linear drive. This screw spindle drive is conventionally composed of a worm gear that is driven by a permanently excited d.c. motor and a screw spindle gear. The worm wheel is fixedly seated on the screw spindle. A non-rotating nut runs thereon and is coupled to a push-out tube in order to convert the motion of the motor into a linear motion. The linear drive can be designed such that it is only able to transmit compressive forces to the back rest.

The following description of the figures is restricted to the explanation of aspects of the invention that are essential for comprehending it. It should be clear that numerous modifications are possible and that a person skilled in the art can in an ordinary way ascertain less important details from the drawings. The drawings described below are not necessarily drawn true-to-scale. Certain regions can be illustrated excessively large in order to elucidate essential details. Furthermore, as also will be understood, the drawings are simplified and do not contain every detail that can exist in a practical embodiment.

Other objects and advantages of the invention also will become apparent upon reading the following detailed description and upon reference to the drawings, in which:

### BRIEF DESCRIPTION OF THE DRAWINGS

FIG. 1 is a perspective of an illustrative hospital bed in accordance with the invention;

FIG. 2 is a perspective of a hospital bed illustrated in FIG. 1 adjusted to a chair position;

FIG. 3 is a side elevational view of the bed frame of the hospital bed shown in FIG. 1 with the back section in a raised position; and

FIG. 4 is an enlarged fragmentary vertical section of the geared connection between the back rest, head rest, and driving motor of the illustrated bed.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

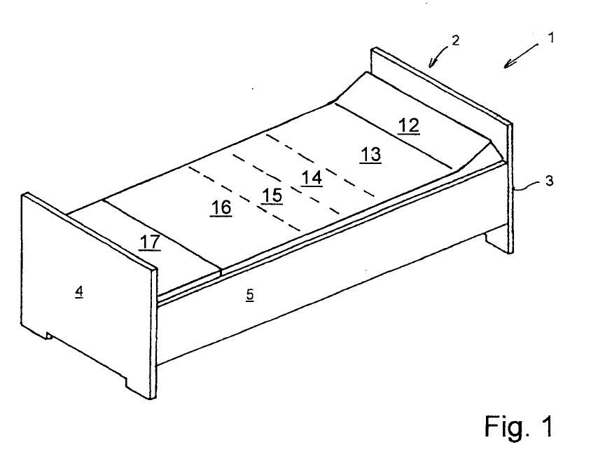

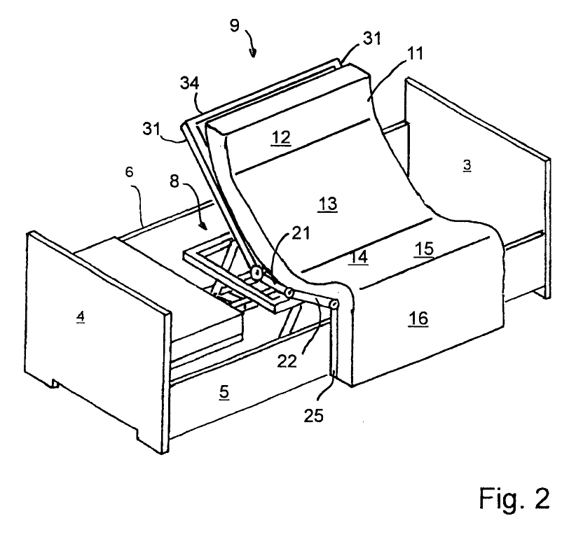

Referring now more particularly to the drawings, there is shown an illustrative rotatable and liftable bed 1 in accordance with the invention depicted in FIG. 1 in a sleeping position and in FIG. 2 in a sitting or chair position. The bed 1 features a bed frame 2 with a head portion 3, a foot portion 4 and side walls 5 and 6. The side wall 5 visible in FIG. 2 is situated in the sleeping position. The lower edge of side wall 5 is spaced from the floor a distance large enough so that a gap exists between the lower edge of the side wall 5 and the floor whereby hospital personnel can place the front part of their feet underneath the bed. The side wall 5 is mounted for vertical movement and reaches a downwardly displaced position in the chair position of the bed 1, as shown in FIG. 2. The support structure of the side wall 5 is explicitly described, for example; in DE 199 12 987 A1, which is incorporated herein by reference.

A lifting mechanism 8 is situated within the bed border 2 and illustrated in FIG. 2. A bed frame 9 that carries a mattress 11 on its top or user side is fixed on the lifting mechanism 8 by means of a rotary hinge (not visible). The lifting mechanism 8 serves to move the bed frame 9 with the mattress 11 situated thereon to different heights. The design of the lifting mechanism is explicitly described, for example, in DE 10 2004 019 144 A1, which is incorporated herein by reference.

The bed frame 9 is divided into several generally planar sections that can be moved relative to one another. The designations of the individual sections essentially correspond to the designations of the body parts of a person lying thereon.

A pivotable head rest 12 which is pivoted upward in FIG. 1 is positioned adjacent head portion 3 and a back rest 13 is positioned adjacent to the head rest 12 in the direction towards the foot portion 4. The back rest 13 is hinged to a central section 14 that in turn is directly connected to the lifting mechanism or lifter 8 by means of the rotary hinge (not shown). A thigh rest 15 follows the central section 14 and transitions into a lower leg rest 16. The bed surface is completed with a foot rest 17. In the rotated state, the foot rest 17 remains stationary in the bed, and only the sections 12 to 16 are moved.

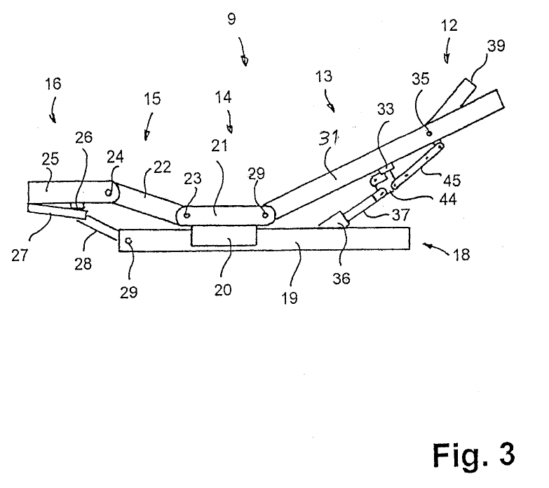

The bed frame 9 is constructed on an intermediate frame 18 that in turn is arranged on the not-shown rotary hinge that connects the intermediate frame 18 to the lifting mechanism 8. Referring to FIG. 3, the intermediate frame 18 consists of two longitudinal side rails that extend parallel to one another, with only one of the longitudinal side rails 19 being visible.

The central section comprises two longitudinal side rails 19 that are arranged on corresponding brackets 20 fixed on the lateral faces of the intermediate frame 18. The spacing between the longitudinal side rails 19 corresponds to the width of the bed surface, and is slightly smaller than the width of the mattress 11.

The central section 14 is formed by the two parallel side rails 21 (only one being visible in FIG. 2) and is not movable relative to the intermediate frame 18. The thigh rest 15 also consists of two parallel side rails 22, of which only one side rail 22 is visible in FIG. 2. The other side rail is situated behind this side rail at, the same height in the plane of projection. The respective side rails 21 and 22 that lie on the same side are connected to one another in an articulated fashion by means of hinges 23 (FIG. 3) on both sides of the bed frame 9. The hinge axes of the two hinges 23 are coaxial to one another.

An elongated side rail 25 that forms the lateral boundary of the lower leg rest 16 together with elongated side rail (not shown) extending parallel thereto on the other side of the bed is hinged to the corresponding side rail 22 on each side by means of a hinge with a hinge axis 24. The hinge axes of the two hinges 24 are coaxial to one another.

The two side rails 25 are connected to one another by a cross brace 26 that extends therebetween. Two parallel rails 27 extend at a distance from one another toward the central section 14 from the free end of the lower leg rest 16. Rollers of a pivoted lever arrangement 28 that is hinged at 29 to the foot end of the intermediate frame 18 between its longitudinal side rails 19 run in the aforementioned rails. The axis of the hinge bearing 29 lies parallel to the hinge axes 23 and 24 such that the lever arrangement 28 can be pivoted accordingly. During the upward and downward pivoting motion, the thigh rest 15 and the lower leg rest 16 are angled relative to each other as shown in FIG. 3 while they are raised or lowered into the rotated position according to FIG. 2. In this position, the lower leg rest 16 extends vertically downward.

The back rest 13 is hinged to the end of the central section 14 and extends toward the head portion 3. The hinge axis is illustrated at 29. The back rest 13 consists of two parallel side rails 31, of which only the side rail on the left side of the bed is visible in FIG. 3 while the side rail 31 extending parallel thereto is illustrated in FIG. 2.

These two side rails 31 are connected to one another, among other things, by a cross brace 33 that is situated near the distal end of the back rest 13. Furthermore, side rails 31 extend past the distal end of the back rest 13. The side rails 31 extend beyond the movable head rest 12 and the ends thereof are connected by means of another cross brace 34 (FIG. 2).

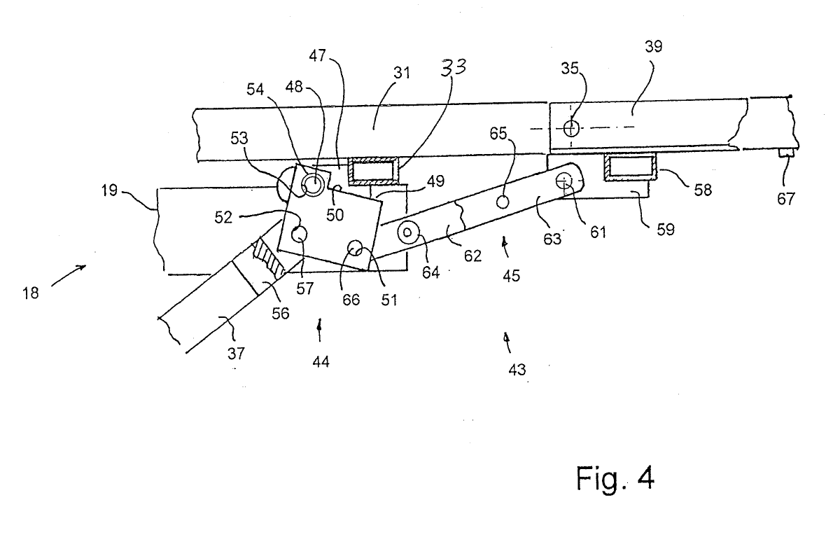

The head rest 12 is supported in a pivoting fashion between the two parallel side rails 31. Its hinge or bending joint 35 is best seen in FIGS. 3 and 4. Hinge 35 is formed, for example, by bolts inserted through the respective side rail 31. This hinge joint 35 facilitates movement of the head rest 12 from a position in which the mattress 11 lies in a straight extension of or planar with the back rest 13 (as shown in FIG. 4), into a raised position as shown in FIGS. 1-3. In the raised position, the mattress 11 is correspondingly slightly angled upward at the head rest by approximately 15° to 20°. The bending point lies at an ergonomically desirable location. Relative to a patient lying in the bed, it lies approximately in the cervical spine region.

A number of spindle-type lifting motors are provided for moving the lifting mechanism 8 in order to rotate the bed frame 9 from the bed position according to FIG. 1 into the chair position according to FIG. 2, as well as to move the thigh rest 15 and the lower leg rest 16, wherein these lifting motors are not illustrated in detail because this is not required for comprehending the invention. The spindle-type lifting motors are activated by a central microprocessor control that receives input signals from a manual control.

The back rest 13 is also moved by means of a spindle-type lifting motor, of which only the rigid guide tube 36 and the movable and telescopically extendible lifting tube 37 are visible in FIG. 3. Sight of the pivoted coupling point at which the motor is mounted is blocked by rail 19.

The kinematic connection between the lifting tube 37 and the back rest 13, as well as the head rest 12, is illustrated in the form of an enlarged detail in FIG. 4. In addition, FIG. 4 shows an enlarged detail of an actuating mechanism 43 that is designed for realizing a sequential motion of the head rest 12 and the back rest 13. A pivotable intermediate lever 44 and a coupling bar 45 form part of the actuating mechanism 43.

The longitudinal side Tail 19 of the intermediate frame 18 situated on the right side of the bed is visible in FIG. 4. The longitudinal side rail 19 extending parallel thereto on the left side of the bed is omitted in order to expose the actuating device 43.

The intermediate lever 44 is supported in a pivoting fashion on the connecting brace or cross brace 33. The brace 33 is situated adjacent to the hinge axis 35 and is offset in the direction towards the central section 15 by a short distance. Two ears 47 that point in the direction of the central section 14 are welded approximately centrally to the cross brace 33 and spaced apart from one another. The intermediate lever 44 is supported between these ears on a cylindrical bolt 48 inserted therein.

The intermediate lever 44 has the shape of an approximately rectangular plate with a rectangular recess at 49. The recess 49 creates a straight stop face 50 that cooperates with the underside of the cross brace 33 of rectangular cross section in order to limit the pivoting motion of the intermediate lever 44 in the counterclockwise direction relative to the illustration.

The intermediate lever 44 contains a total of three holes 51, 52 and 53 that act as individual hinges. A bushing 54 extending through the hole 53 is welded or otherwise secured, for example, to the intermediate lever 44. The length of the bushing 54 corresponds to the distance between the pair of spaced apart rigid ears 47. The bushing 54 serves to support the intermediate lever 44 on the inserted bolt 48 in a non-tilting manner to create a supporting hinge 53. This ensures that the intermediate lever 44 can only move by pivoting about the axis of the bolt 48, and therefore parallel to the other hinge axes of the bed frame 9.

A fork head 56 has a fork end that overlaps the intermediate lever 44 and is screwed into or otherwise secured to the lifting tube 37 of the screw spindle motor. A cylindrical hinge pin 57 extends through the aligned holes of fork head 56 and intermediate lever 44 and thus produces a hinge-like connection between the fork head 56 and the pivotable intermediate lever 44 at driving hinge 52.

The pivoting motion of the intermediate lever 44 is transmitted to the head rest 12 through the coupling bar 45. The left longitudinal side rail 39 of the head rest 12 is visible in the figure and realized in the form of an L-shaped profile similar to the other longitudinal side rail. The two longitudinal side rails 39 are connected to one another by means of a cross brace 58. The cross brace 58 is situated in the vicinity of the hinge pin 35. An ear 59 that points in the direction of the pivoted or intermediate lever 44 is fixed on the cross brace 58. It is provided with a transverse hole into which a cylindrical bolt 61 is inserted in order to connect the ear 59 and the coupling bar 45.

The coupling bar 45 consists of two congruent partial braces 62 and 63 that extend at a distance from one another and are respectively spaced apart in accordance with the thickness of the pivoted lever 44 or the ear 59 by means of several spacers 64. The two partial braces 62 and 63 are rigidly connected to one another by means of rivets 65 extending through the partial braces.

The coupling bar 45 also contains a corresponding through-hole in the two partial braces 62 and 63 in the vicinity of the pivoted lever 44. A cylindrical pin 66 extending through these holes, as well as through the hole 51 of intermediate lever 44, forms the coupling bar hinge for producing the articulated connection between the coupling bar 45 and the intermediate lever 44.

The intermediate lever 44 is hinged to the back rest 13 by means of the supporting hinge 53 on the back rest 13 and the intermediate lever 44 is connected to the linear drive 36, 37 by means of the driving hinge 52. If a plane is drawn to connect the axes of driving hinge 52 and supporting hinge 53, the common plane is angled relative to a plane defined by the back rest 13 by more than 60°, and preferably by more than 80°.

The intermediate lever 44 is connected to the coupling bar 45 by means of a coupling bar hinge 51. If a plane is drawn to connect the axes of the coupling bar hinge 51 and the supporting hinge 53, the common plane is angled relative to the plane defined by the back rest 13 by more than 80° when the back rest 13 and the head rest 12 lie in a common plane.

The effective radius by means of which the coupling bar 45 acts on the head rest 12 is about the same distance as that between the hole 53 and the hole 52. The arrangement is realized approximately such that the pivoted or intermediate lever 44 travels over the same angular range as the head rest 12.

In order to prevent the head rest 12 from falling down, stops 67 are positioned on the distal end of the longitudinal side rails 31, wherein the longitudinal side rails 39 of the head rest bear against these stops when the bed surface is completely flat.

In operation, in the sleeping or flat position, the screw spindle drive responsible for the back rest 13 is completely retracted, i.e., the lifting tube 37 is retracted to such a degree that the head rest 12 and its two longitudinal side rails 39 engage the stops 67. In order to simplify the adjustment, the corresponding screw spindle drive is preferably a decoupled drive, namely such that only a compressive force can be exerted upon the lifting tube 37. The motor itself can therefore return to practically any end position without creating stress in the actuating device 43. In the lowered or sleeping position, the back rest 13 and the cross brace 33 engage the upper side of the longitudinal side rails 19 of the intermediate frame 18. A plane extending through or connecting the axes of the holes 52 and 53 extends at an angle of approximately 15° relative to a line extending perpendicular (or vertical as viewed in FIG. 4) to the lowered back rest 13.

Referring to FIG. 4, if the corresponding spindle-type lifting motor is activated in this position in order to extend the lifting tube 37 that engages at an acute angle of approximately 30° relative to the plane of the back rest 13, the intermediate lever 44 is initially pivoted in the counterclockwise direction. The pivoting motion of the intermediate lever 44 is transmitted to the ear 59 of the head rest 12 by means of the coupling bar 45. The head rest 12 is raised from the lying flat position in accordance with the extension of the lifting tube 37 and the resulting pivoting motion of the intermediate lever 44. The extension of the lifting tube 37 controls how far the head rest 12 should be raised. Once the user has reached a comfortable head position, the spindle-type lifting motor can be stopped by releasing the respective control key in order to end the lifting motion of the lifting tube 37. A person lying in the bed therefore can adjust a comfortable head position, for example, for sleeping in the sleeping position of the bed. The user is not dependent on assistance in order to raise the head rest 12.

By continuing to activate the spindle-type lifting motor, the lifting tube 37 is extended until the stop face 50 of intermediate lever 44 contacts the underside of the cross brace 33 which establishes the maximum pivoting angle of the intermediate lever 44 relative to the longitudinal side rail 31 of the back rest 13. This pivoting motion corresponds to raising the head rest by approximately 15° to no more than 20°, wherein 20° can be rather excessive from the perspective of user comfort.

Still further actuation of the corresponding drive which causes further extension of the lifting tube 37 will also causes the back rest 13 to rise after the head rest 12 is raised to its maximum raised position.

The head rest 12 remains at the respective maximum raised position or angle relative to the back rest 13 at any angular adjustment of the back rest 13. FIGS. 2 and 3 show intermediate positions with different angles of inclination of the back rest 13 but in each instance, head rest 12 is at its maximum raised position.

If the corresponding drive is actuated in the opposite direction, the lifting tube 37 is retracted. This initially causes the back rest 13 to be lowered until it has returned to the horizontal position. In the horizontal position, an additional downward movement of back rest 13 is prevented due to the positive interaction between the cross brace 33 and the side rails 19 of the intermediate frame 18. The intermediate lever 44 only begins to pivot relative to the back rest 13 once the backrest has reached the horizontal position and the intermediate lever 44 no longer transmits a force to the brace 33. At such point, additional retraction of tube 37 causes clockwise (as viewed in FIG. 4) rotation of intermediate lever 44 and the lowering of the head rest 12.

The user is able to move the head rest 12 into an ergonomically comfortable position without assistance and without the utilization of another electric drive. Practical experience shows that the maximum raised position of the head rest 12 is typically desired in any sitting position in which the back rest 13 is raised to some extent. The automatic drive of the head rest 12 also ensures the correct sequence and eliminates additional expenditures for control technology in the central controller of the bed. If desired, the pivoting stop formed by the stop face 50 and the cross brace 33 could be accommodated in the region of the longitudinal side rails 39 of the head rest 12.

An advantage of the disclosed embodiment can be seen in that the motion of the head rest can be stopped, if desired, by disengaging the coupling bar 45 without requiring any other modifications of the remaining drive of the back rest. The hospital personnel therefore can easily reset the bed into another operating mode if this is desired for special illnesses.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-21. (canceled)

22. An adjustable bed comprising:
a bed frame having first, second and third generally planar sections positioned along a longitudinal axis of said frame;
said second section being connected to said first section and rotatable about a first horizontal axis of rotation;
said third section being connected to said second section and rotatable about a second horizontal axis of rotation;
a rotation drive lever pivotally secured to the second section at a location generally adjacent an operational side of said frame;
a linear drive generally adjacent the operational side of the bed frame with a movable driven end connected to the rotational drive lever, and
a coupling bar connected to both the rotational drive lever and the third section.

23. The adjustable bed according to claim 22, wherein the second section includes two elongated side rails, each of which is connected to the first section by means of a hinge.

24. The adjustable bed according to claim 22, wherein the second section includes two elongated side rails having ends that extend and project beyond the third section, the ends being interconnected by a cross-member.

25. The adjustable bed according to claim 24, wherein the third section is supported in a pivotable manner between the elongated side rails of the second section.

26. The adjustable bed according to claim 22, wherein the rotational drive lever includes a stop to limit rotation thereof.

27. The adjustable bed according to claim 22, further including a stop associated with the rotational drive lever to limit pivoting motion of the rotational drive lever away from the linear drive.

28. The adjustable bed according to claim 22, wherein the rotational drive lever is rotatably mounted to the third section by means of a supporting hinge on the third section.

29. The adjustable bed according to claim 28, wherein the rotational drive lever is connected to the linear drive by means of a driving hinge wherein the axis of both the supporting and driving hinges lie in a common place.

30. The adjustable bed according to claim 29, wherein the common plane is angled relative to a plane defined by the second section by more than 60°.

31. The adjustable bed according to claim 30, wherein the angle is greater than 80°.

32. The adjustable bed according to claim 28, wherein the rotational drive lever is connected to the coupling bar by a coupling bar hinge.

33. The adjustable bed according to claim 32, wherein the coupling bar hinge and the supporting hinge each have an axis and the coupling bar hinge axis and the supporting hinge lie in a common plane.

34. The adjustable bed according to claim 33, wherein the common plane is angled relative to a plane defined by the second section by more than 80° when the second section and the third section lie in a common plane.

35. The adjustable bed according to claim 22, wherein the coupling bar includes two congruent partial braces connected to one another by space elements.

36. The adjustable bed according to claim 35, wherein the distance between the partial braces of the coupling bar generally corresponds to the thickness of the rotational drive lever.

37. The adjustable bed according to claim 22, wherein the coupling bar acts on the third section with an effective lever length and the lever length is between 0.8-times and 1.5-times the axial spacing between the coupling bar hinge and the supporting hinge.

38. The adjustable bed according to claim 22, wherein the linear drive consists of a screw spindle motor.

39. The adjustable bed according to claim 38, wherein the linear drive is only coupled to the rotational drive lever in the compression direction.

40. The adjustable bed according to claim 22, wherein a stop is operatively associated with the third section and limits motion of the third section into a lowered position.

41. The adjustable bed according to claim 22, wherein the linear drive is positioned generally adjacent said first horizontal axis.
